(19) United States
(12) Patent Application Publication
(10) Pub. No.: US 2018/0205714 A1
(43) Pub. Date: Jul. 19, 2018

(54) System and Method for Authenticating Electronic Tags

(71) Applicant: ETAS Embedded Systems Canada Inc., Waterloo (CA)

(72) Inventors: Anthony ROSATI, Ottawa (CA); Jason SMITH, Waterloo (CA)

(21) Appl. No.: 15/822,603

(22) Filed: Nov. 27, 2017

Related U.S. Application Data
(60) Provisional application No. 62/446,590, filed on Jan. 16, 2017.

(51) Int. Cl. H04L 29/06; H04L 9/32; H04L 9/06; G06K 7/10

(52) U.S. Cl. CPC H04L 63/061; H04L 9/3247; G06K 7/10366; H04L 63/123; H04L 9/06; H04L 9/3242

(57) ABSTRACT

Provided is a method of programming an identification tag, the tag comprising a cryptographic engine. The method comprises writing a random value to the tag as a private key; reading at least one value identifying an attribute of the tag; encrypting the at least one value using the private key to generate an encrypted value; digitally signing the encrypted value to generate a digital signature; and programming the tag to include the digital signature and the encrypted value. There is also provided a method of verifying an identification tag, by reading a signature stored on the tag; verifying the signature; reading at least one value identifying an attribute of the tag; having the tag encrypt the at least one value using its cryptographic engine and a private key written to the tag to generate an encrypted value; and comparing the encrypted value with an encrypted value stored on the tag.

### CROSS-REFERENCE TO RELATED APPLICATION(S)

This application claims priority to U.S. Provisional Patent Application No. 62/446,590 filed on Jan. 16, 2017, the contents of which are incorporated herein by reference.

### TECHNICAL FIELD

The following relates to systems and methods for authenticating electronic tags.

### BACKGROUND

The verification of the authenticity of an item is often done by labelling the item with a distinguishable piece of identification. Traditionally such identification is the label bearing the maker's name and product name, but the ability to reproduce such labels by counterfeiters has required more sophisticated solutions. Identification techniques currently used include engraving, holograms, two dimensional bar codes (typically referred to as QR codes), and identifiers using radio frequency, commonly referred to as RFID tags, and which include near field communication (NFC) tags as a subset of RFID tags. The RFID tags are not as easily copied and are more expensive to produce, and so act as a deterrent to the counterfeiter. The tags can be scanned to identify the manufacturer and indicate if an item is authentic or otherwise fraudulent. Although the tags are harder to copy, tags may be substituted from one product of the manufacturer to another and for high value goods the cost of manufacturing the tags is offset by the large profit available.

RFID tag readers and RFID tags function through the use of electromagnetic modulation. To read an NFC tag, the NFC reader emits an electromagnetic field with specific properties to interact with the tag. The tag becomes powered by the reader itself after interaction has occurred allowing the tag to modulate the electromagnetic field. The modulated field is then read and analysed by the reader and the information transferred from the tag to the reader, thus allowing for the data to be processed.

The process of fabricating products may be performed under strictly controlled environments and access to the tags themselves restricted within the manufacturing environment. Such a controlled environment ensures that the opportunity to tamper with a product before deployment is reduced.

However, the volume of identification tags that are required in a large manufacturing concern creates a problem in maintaining control of the issued tags. Large quantities of identification tags can become lost in sizeable manufacturing operations, or may be discarded with items rejected for quality control purposes. The integrity of the tags are at risk, since if genuine tags become lost they can be applied to fraudulent items and still be scanned to indicate that they are genuine.

Increased security can be obtained by using a more sophisticated identification method. The increase in complexity of the tag increases the cost per tag. RFID tags with active cryptographic functionality are powered and are typically more expensive than their passive unpowered counterparts, such as NFC tags. Powered RFID tags contain a security chip as well as challenge-and-response-based cryptographic functionality.

Where cryptographic functionality is available, data can be digitally signed to increase the reliability of the underlying data. Signatures are used to check the authenticity of data that has been signed. If a signature is not recognized during the verification stage an error will normally occur. Signatures can be applied to various types of data strings. However, the verification of the signature only indicates that the tag has been signed by the manufacturer or producer and does not indicate the origins of the product to which the tag is applied.

It is therefore an object of the present invention to obviate or mitigate at least one of the above disadvantages.

### SUMMARY OF THE INVENTION

In one aspect, there is provided a method of programming an identification tag, the tag comprising a cryptographic engine, the method comprising: writing a random value to the tag as a private key; reading at least one value identifying an attribute of the tag; encrypting the at least one value using the private key to generate an encrypted value; digitally signing the encrypted value to generate a digital signature; and programming the tag to include the digital signature and the encrypted value.

In another aspect, there is provided a method of verifying an identification tag, the tag comprising a cryptographic engine, the method comprising: reading a signature stored on the tag; verifying the signature; reading at least one value identifying an attribute of the tag; having the tag encrypt the at least one value using its cryptographic engine and a private key written to the tag to generate an encrypted value; and comparing the encrypted value with an encrypted value stored on the tag, the encrypted value stored on the tag having been digitally signed to generate the signature stored on the tag.

There are also provided computer readable media and devices configured for performing the methods.

There is also provided an identification tag programmed according to the method of programming an identification tag. The tag can be an RFID tag, such as an NFC tag.

### BRIEF DESCRIPTION OF THE DRAWINGS

Embodiments will now be described by way of example, with reference to the accompanying drawings in which:

FIG. 1 illustrates an electronic tag affixed to a product and being readable by a tag reader;

FIG. 2 is a schematic diagram illustrating programming a tag;

FIG. 3 is a flow chart illustrating operations performed in verifying the authenticity of a tag programmed as shown in FIG. 3;

FIG. 4 is a block diagram illustrating exemplary components of an electronic device configured to operate as a tag reader;

FIG. 5A is a representation of a data string in an NFC tag memory;

FIG. 5B is a representation of a data string in an NFC tag illustrating a representative uniform resource locator (URL) structure;

FIG. 6 illustrates an implementation for verifying the authenticity of electronic tags using an electronic device and a web server; and

FIG. 7 is a flow chart illustrating operations performed in an implementation using a URL structure such as that shown in FIG. 5.

### DETAILED DESCRIPTION OF THE INVENTION

In general terms the following describes a method used to authenticate an item using an identification tag. At the time of manufacture, the tags are created with various hardware attributes (HA), including a unique identifier (UID), NFC forum tag type, tag size, max NDEF message size, etc. One or more of the HAs are encrypted with a private key written to the tag, the tag having a cryptographic engine thereon. The encrypted HA(s) are then signed and the tag programmed in order to enable subsequent authentication. To verify the tag, the HA(s) is/are encrypted by the tag using its embedded private key to be compared with the value that was signed when the tag was programmed. In this way, cloning of a tag is prevented since the signature is bound to both the tag and the private key of the tag's cryptographic engine.

It has been found that cloning a signed tag may be possible with chips that have fully programmable hardware attributes. While such cloning typically requires significant efforts and resources, it can be done. The cryptographic engine herein described enables the HA(s) to be encrypted using the private key of the tag, thus preventing the aforementioned cloning efforts, since the private key cannot be read out of the tag once the tag is programmed.

Moreover, with the private key programmed into the chip in the way described herein, a master key is not required, thus eliminating a potential vulnerability with managing a master key. For example, in traditional approaches to programming tags with private keys, such as advanced encryption standard (AES) private keys, requires the secure management of the master key. The master key that would be used to encrypt data associated with the tag and generate a private key for that chip needs to be securely stored by every reader that is used in the system. As such, any single breach renders the entire system broken, which is particularly problematic in large systems with many tags and many readers.

Furthermore, it may be noted that such a private key does not need to be known by any party, and is not recorded. The private key also makes each chip unique.

By having an onboard cryptographic engine such as an AES engine, the tag can encrypt the HA(s) in real time for comparison by the reader with what is stored on the tag, without requiring the reader to possess a master key. As such, a vulnerability in the system is avoided while eliminating cloning of the tags.

Such a configuration using tags that include cryptographic engines such as AES, can also be optionally integrated into a system such as that described in U.S. Pat. No. 9,697,298; and co-pending U.S. patent application Ser. No. 15/614,374, the contents of both being incorporated herein by reference. Implementations in such a system are also summarized below.

For example, the tag can be encoded with a signature of a message that includes a URL, and optionally a serial number associated with a product to which the tag is to be attached. The URL embeds various data such as one or more of the HAs, a serial number, etc., which can be used to verify the authenticity of the tag when verifying the signature. When a tag is read, the message including the URL can be recovered and the signature verified by the processor of the reader. This can be done to ensure that the URL in the message is one designated by the signer. The data in the signature can then be used to verify the authenticity of the tag and/or to detect tampering. For example, if the signature is successfully verified, but the data in the signature does not match that on the tag, the tag can be considered a cloned tag and steps taken accordingly. The results of the verification can also be displayed to a user, e.g., using an available display on the electronic device including or otherwise acting as the tag reader.

In some implementations, after the signature has been verified, the URL can be used to redirect the tag reader device to a particular web site via a web server. The web server can, at the same time, track tag verifications and provide a consistent redirect web address for various customers such as companies selling the products to which the tags are attached. The URL can also be used to send an HTTP query to a web server along with the serial number (SN). The web server checks the SN in a pre-established table or database of items and obtains the correct HA(s) (e.g., UID) and a description of the item. The HA obtained is compared with the HA associated with the tag, in turn associated with the item. The authenticity of the item may then be confirmed when the UIDs are the same. Optionally, further confirmation may be provided from the description of the product and with the actual product. Preferably, the tags are NFC tags that are integrated into a product at the time of manufacture to ensure they are affixed in a secure environment. This reduces the chance that tags can be used to falsely identify a fraudulent item.

NFC tag readers in the form of mobile electronic devices such as smart phones may be used to read the information contained in the tags. The use of smartphones eliminates the need for specialized tag readers. It also enables anyone with a smartphone that is NFC enabled to be able to confirm the authenticity of an item.

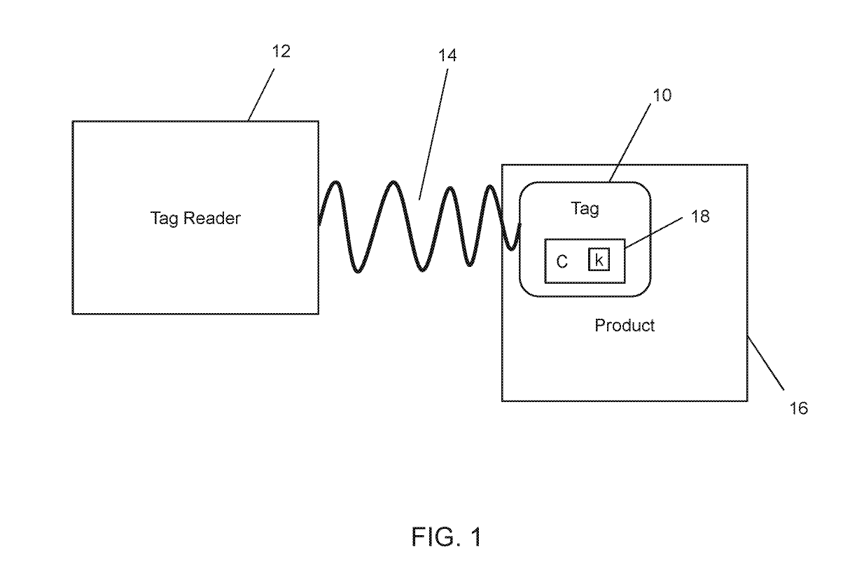

Turning now to the figures, FIG. 1 illustrates a tag 10, such as an NFC tag or other tag type that is configured to be read by a tag reader 12 using a short-range communication channel 14, preferably in a contactless manner (e.g., by placing the tag 10 in close proximity to the tag reader 12 or by tapping the tag 10, etc.) The tag 10 is affixed to a product 16 and includes an on-board cryptographic engine (C) 18 such as one that is configured according to the AES. The tag 10 and its cryptographic engine 18 are embodied using a chip that is designed such that once a private key k is written into the tag 10, it cannot be read out in any way. This can be done by writing k to special memory (e.g., within the cryptographic engine 18) that cannot be read or reprogrammed, e.g., one-time-programmable (OTP) memory. There are various mechanisms that can be used to prevent such private key reading, e.g., decapping the chip and reading bits under a microscope. To address these events, the cryptographic engine 18 can be designed to destroy the private key k so that it cannot be recovered, e.g., in the event of decapping. Decapping can be prevented using a special coating that destroys the chip if one tries to decap. For example, passport RFID chips and chips used in credit cards are known to use such a coating.

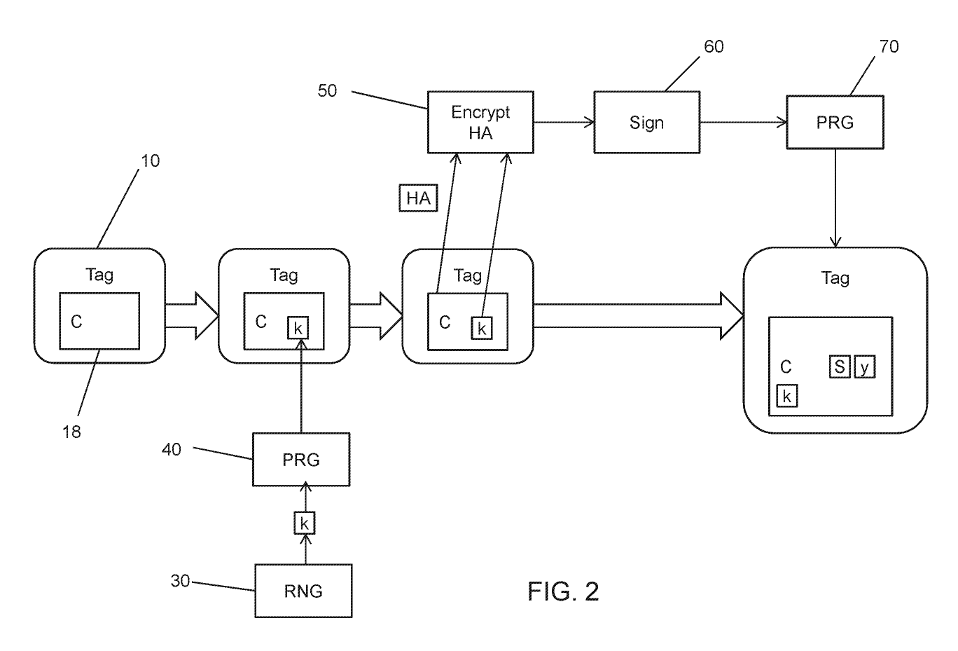

FIG. 2 illustrates how a tag 10 can be programmed to prevent cloning as discussed above. A tag 10 having a cryptographic engine 18 is programed with a random key k. For example, a random number generator (RNG) 30 can be used to generate a value k that is then programmed to the tag 10 using a programming module (PRG) 40. One or more hardware attributes (HA) may then be read from the tag 10 and the HA(s) (or a hashed version thereof—denoted x in the examples herein) encrypted by an encryption operation 50, using the onboard private key k, to generate a value y. This value y is then signed using a signing operation 60, e.g., by implementing an ECDSA or RSA signing scheme (see for example the NFC Forum Signature RTD 2.0 ECDSA signing). It may be noted that signing y by a valid author cryptographically binds the tag 10 to the author (and associated product), preventing it from being cloned. The tag 10 is then programmed, e.g. using a final programming operation (PRG) 70. The programmed tag 10 includes not only the private key k that is permanently written to the tag 10, but also the signature S and the encrypted value y.

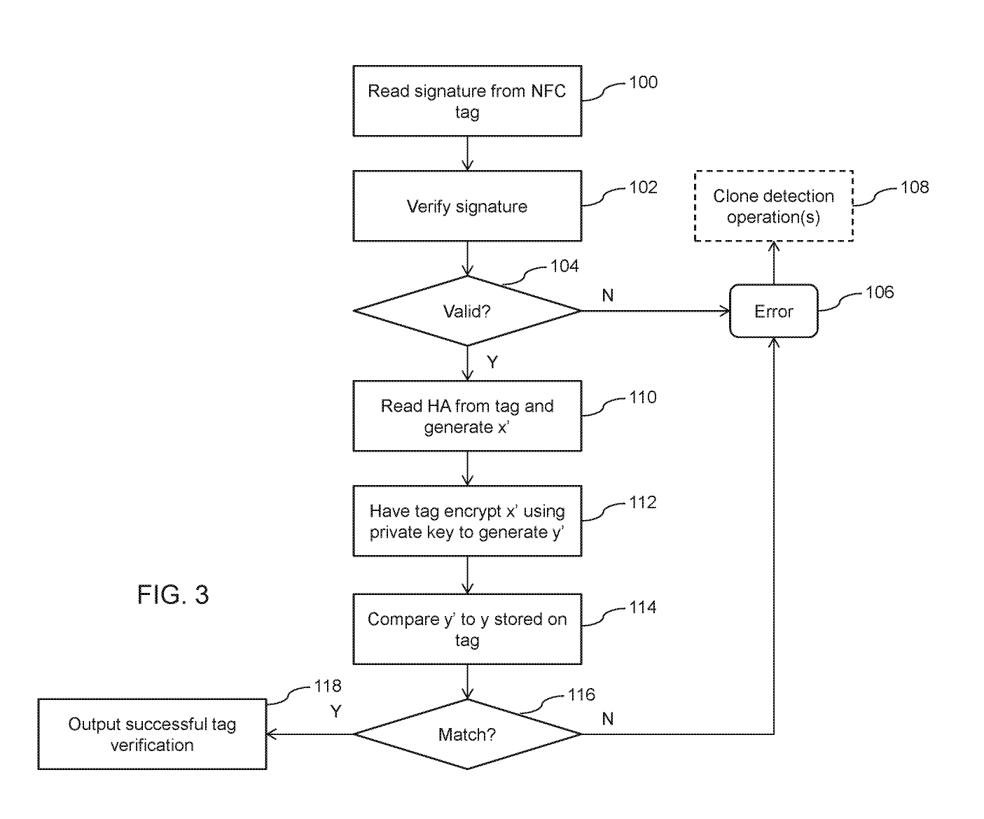

FIG. 3 illustrates operations that are performed in verifying a programmed tag 10. At step 100 the signature S is read from the tag 10 and the signature is verified at step 102 according to the signature scheme that was used in generating the signature S. If the verification of the signature is not successful at step 104, an error message or other alert or notification can be generated at step 106.

In such cases, the error message can trigger one or more optional clone detection operations to be performed at step 108, since a successful signature verification but failed comparison of HAs 42 is a good indication that the signature of a legitimate tag 11 was copied to a grey market or otherwise illegitimate tag 11 to create a “clone”. The clone detection operations can include gathering geo-location information for the reader 12 (e.g. using smart phone GPS capabilities) and sending clone-detection alerts to the web server or other third party service or authority. Such information can be tracked to pinpoint cloning operations, distribution centres, retailers, etc. This information can also be provided to the manufacturer of the tags 10, e.g., to track potential cloning and grey market activity within their supply chain.

The HA(s) 252 is/are read by the tag reader 10 at step 110 to create x′. It can be appreciated that this may include generating a hash of the HA(s) 252. At step 112, the tag's cryptographic engine 18 is used to encrypt x′ using its private key k to produce y′. The value y′ generated during the read verification is compared to y that was signed during tag programming and which is stored on the tag 10 as shown in FIG. 2. If there is a match at step 116, the tag reader 12 can output a successful scan, e.g., by displaying a message to the user at step 118.

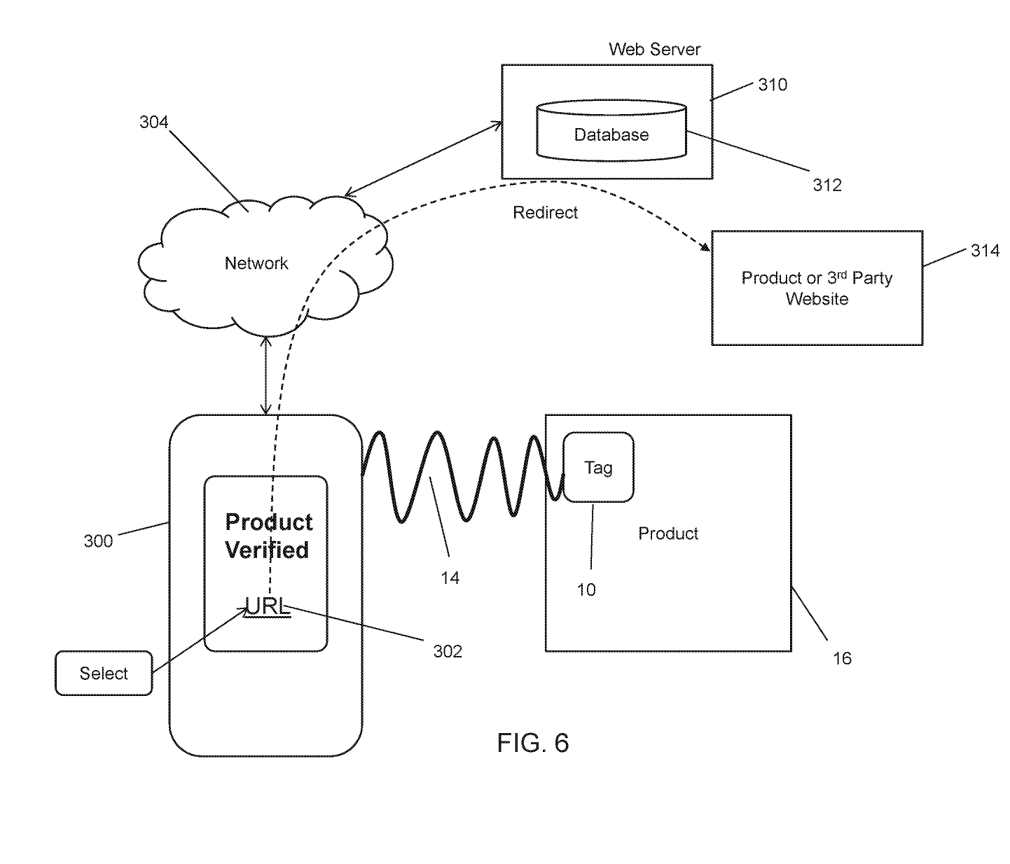

The signing and verification of a tag 10 can therefore be performed without requiring a master key that would need to be managed to avoid the system being compromised. Also, tags 10 programmed as shown in FIG. 2 can be readily integrated into a system as that shown in FIG. 6, described below.

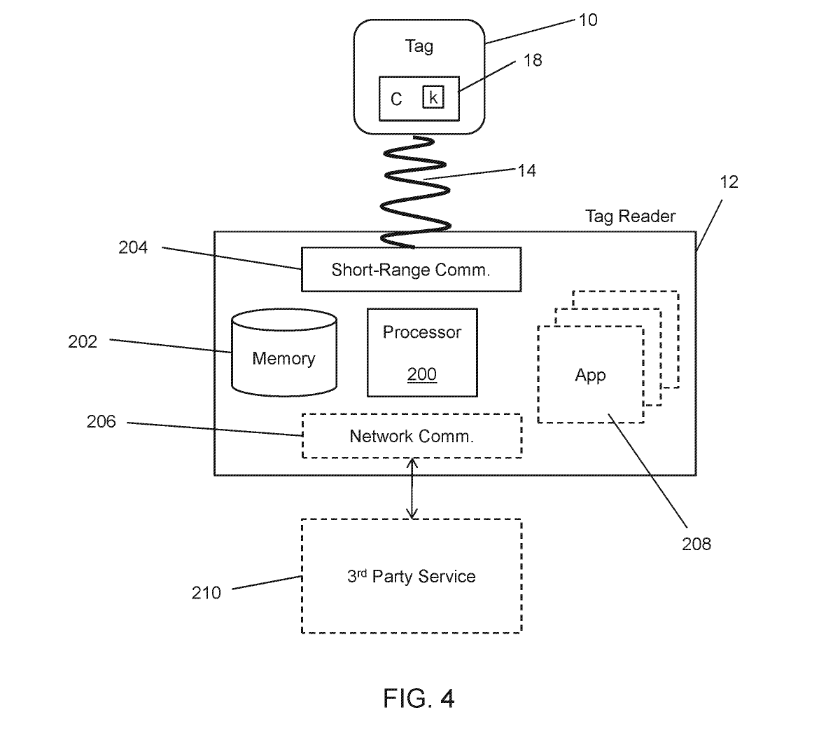

FIG. 4 illustrates a block diagram of an example configuration for a tag reader 12. The tag reader 12 includes a processor 200 and memory 202 that are configured to read and verify the tags 10. The tag data can be read by interfacing with the tag 10 via a short-range communication interface 204. The processor 200 can include or otherwise have access to a cryptographic module that is capable of verifying the signature S and for participating in the verification of the tag 10 as illustrated in FIG. 3. Optionally, the tag reader 12 can include additional functionality or the tag reader 12 can be a module embedded in another device such as a smartphone. In such embodiments, the tag reader 12 may also include one or more network communication interfaces 206 that enable the tag reader 12 to communicate with third party services 210 and/or other servers or entities via one or more networks. The tag reader 208 may also include one or more apps 208 that enable the tag reader 12 to provide additional information to a user, as exemplified below.

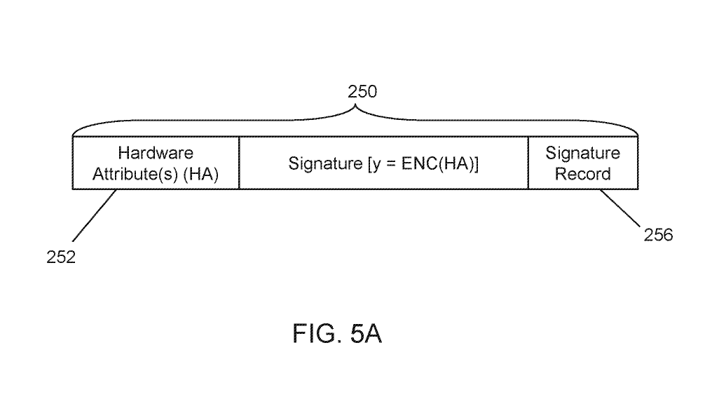

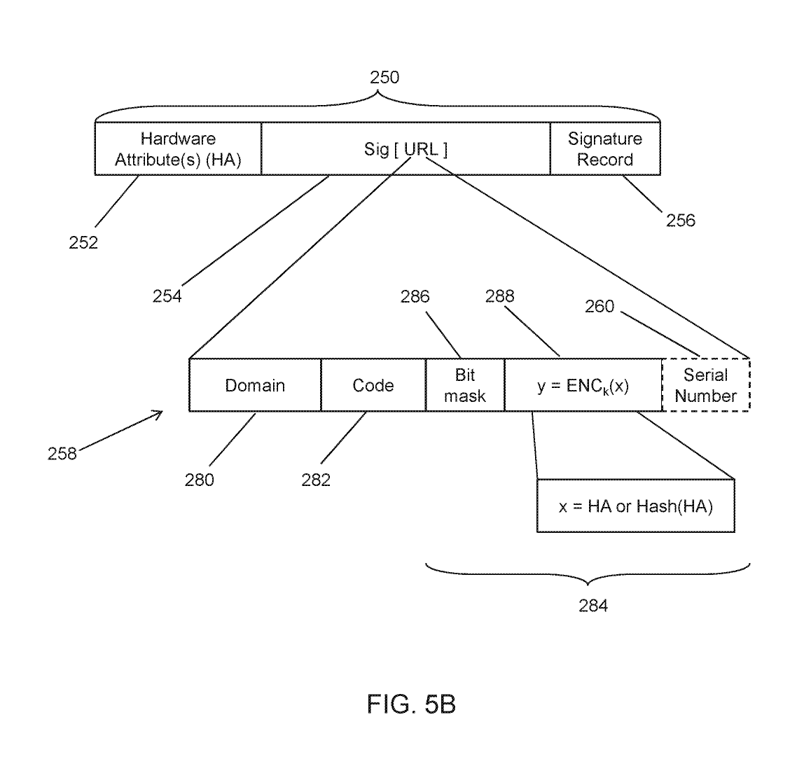

Referring now to FIG. 5A, each of the tags 10 has memory 250, which includes various hardware attributes (HAs) 252, such as a UID, NFC forum tag type, tag size, max NDEF message size, etc. For example, since the tag 10 typically has a limited memory 250 in which is embedded at the time of manufacture, a secure UID, which can be a particularly good attribute to use in order to authenticate a tag 10 since the UID is by its nature meant to be unique. The UID is programmed at the time of manufacture and cannot be altered through subsequent manipulation. The other HAs 252 would likewise be set at the time of manufacture. The memory 250 also includes a signature 254 on y (i.e. one can sign the encrypted HA(s)), and can include a signature record 256.

FIG. 5B illustrates an optional implementation, in which the signature 254 is generated on a message, e.g., having a target URL 258, particularly when a suitable amount of memory 250 is available.

The URL 258 includes a domain 280 (e.g. https://webserver.com), and in this example a code 282. The code 282 can be used to identify a particular entity associated with the products 16 to which the tag 10 is affixed, e.g., the manufacturer. The URL 258 would in such an example direct the tag reader 12 to an area within the domain 280 associated with a web server 310 (see FIG. 6 described below). The URL 258 also embeds verification data 284, which can be used by the tag reader 12 to verify the tag 10 at the tag reader 12, to perform additional checks using web queries, etc. In this example, the verification data 284 includes a bit mask 286 for identifying what is included within a hash 288 of the HA 252. It can be appreciated that the HA 252 can also be included in plaintext and thus a bit mask 286 would be optional.

The following Table 1 illustrates an example set of bitmask 286 values:

TABLE 1
Example Bitmask values

| | |
|---|---|
| 0001 | UID |
| 0010 | NFC Forum Tag Type (Type 1, 2, 3, or 4) |
| 0100 | Tag Size (in bytes) |
| 1000 | Max NDEF Message Size (in bytes) |

Assuming the bitmask values in the above, a few example URLs 258 are now provided. In a first example, only a UID is embedded in the URL 258, and the UID is not hashed and therefore does not include the bitmask 286:

https://trst.ca/abcdef?u=<UID>. The “trst.ca” value corresponds to the domain 280, the “abcdef” value corresponds to the code 282, and the characters following the “?” form the embedded data 284. In this example, only a UID is embedded.

In a second example, the above URL 258 includes a hash of the UID, and thus a bitmask 286:

https://trst.ca/abcdef?b=1&d=<HashOfUID>. The “b=1&d” corresponds to the bitmask 286 and indicates that the following value is a hash of the UID.

In a third example, all four of the above HAs 252 are embedded, but are not hashed and no bitmask 286 is included:

https://trst.ca/abcdef?u=<UID>&t=<TagType>&s=<TagSize>&m=<MaxNDEFSize>. The t=<TagType>identifies the tag type, the s=<TagSize>identifies the tag size, and the m=<MaxNDEFSize>identifies the message size.

In a fourth example, the URL 258 in the third example includes a hash of all four HAs 252 and thus includes a bit mask 286:

https://trst.ca/abcdef?b=f&d=<HashOfAllHardwareAttributes>.

In the configuration shown in FIG. 5B, a product identifier serial number (SN) 260 related to the specific item 16 is also optionally embedded in the URL 258. As will be described more fully below, the serial number 260 is attributed to the tag 10 during the integration with the item 16 and duplicates the unique identification provided by the HA 258 (e.g. UID). The use of a separate serial number can also, however, avoid the need to read the HA 252 during integration and thereby simplifies the process in some implementations. The message containing the URL 258 is signed using a convenient signature protocol, such as an ECDSA signature protocol and the signature record 256 can be formatted according to the NFC Forum Signature RTD 2.0 specifications, and appended to the signature and stored in the memory 250. The signature 254 is created by the author of the tag 10 using the author's private key and the corresponding public key is included in the signature record 256, preferably as a certificate of a trusted certificate authority whose public key is distributed within the system. In this example, the URL 258 includes the value y, which encrypts the HA 252 or hash of the HA 252 using the tag's private key k. As such, it can be appreciated that the cryptographic module-enabled tags can be readily integrated into a system, such as that shown in FIG. 6, which utilizes the URL 258.

As shown in FIG.6, an authentication system that utilizes the structure shown in FIG. 5B has three primary communicating components, namely an electronic device 300 configured as or including a tag reader 12, a tag 10 and a web based server 310. In the present embodiment, the tag 10 is an NFC tag, although it will be appreciated other forms of RFID tags may be used, that is attached to an item 16 whose authenticity is to be confirmed. The NFC tag 10 is affixed to the item 16 during the manufacturing process as will be described in greater detail below.

The reader 12 may be implemented in a mobile electronic device, such as a smart-phone or other personal mobile communications device 300 with a near field communication (NFC) enabled module, and is used to read the tag 10 and communicate with the web server 310. The reader 12 communicates with the NFC tag 10 to read the data stored on the tag 10. As described herein, the NFC tag reader 12 is advantageously a mobile electronic device such as a smartphone. This enables the reader to be implemented into an already existing product that is already in the hands of consumers. This reduces or eliminates the cost of purchasing specialized NFC tag readers. It will be appreciated that other forms of readers may be used, such as dedicated point of sale (POS) devices or inventory control scanners.

It can be seen that the tag reader 12 is also enabled to communicate with the web-based server 310. The server 310 includes a database 312 that contains a table providing a correlation between the UID of a tag 10 and the serial number of the item to which the tag 10 is appended and a description of the item. Locations within the database 312 are accessed using a specific URL 258 for each location so it may be queried by the reader 12.

Two wireless communication protocols that may be used during the verification process are indicated at 14 and 15. Communication protocol 14 between the tag 10 and reader 12 is conveniently performed using RFID technology, in particular NFC technology. The communication range has a theoretical maximum of about 20 cm and a practical range between about 2 cm and 4 cm between the tag reader and tag. The other wireless protocol 15 that is used to communicate with the web server 310 can be WLAN, GSM, HSDPA, LTE or any other wireless technology that provides internet access. As shown in FIG. 6, the electronic device 300 that includes the tag reader 12 may display a verification message and include a hyperlink 302 or other selectable option that is associated with the URL 258. In this way, the URL 258 can be used to send a redirect to a product or other 3^{rd} party website 314 via the web server 310. For example, a shirt or hat having a tag 10 affixed thereto can be scanned by a consumer and upon successful verification the URL 258 can be used to redirect the consumer to the manufacturer's website.

In general terms, the authenticity of the item 16 is verified by using the reader 12 to extract information pertaining to the item 16 from the tag 10. The information is contained in a message stored on the tag 10 that is signed so its authenticity can be verified. Once the signature has been verified, the reader 12 can provide confirmation of verification as shown in FIG. 6 with an option to redirect the user via the web server 310, or can optionally use the recovered information to query the database 312 in the web server 310. In such a case, the web server 310 extracts information pertaining to the item 16. A comparison can be made between the item 16 and the information extracted from the database 312. The comparison may be performed by the reader 12, which requires the information to be sent to the reader, or may be performed by the web server 310 and a “pass/fail” message provided to the reader 12 either transparently to the user or using a visual feedback as shown in FIG. 6. Both alternatives are described in more detail below.

The NFC tag 10 should preferably be affixed to or integrated into a product or item in a controlled environment, e.g. as illustrated in FIG. 2. After having its cryptographic engine 18 programmed with its private key k, the tag 10 can be affixed to the desired item at the final fabrication stage of production, preferably after quality control inspection. Each of the tags 10 has a UID embedded at the time of manufacturing the tag 10, and will also have various other HAs 252. As indicated above, a serial number 260 can be added to the memory 250 during integration by embedding the serial number 260 in the URL 258. The URL 258 with the embedded verification data thus forms a message which can be signed by the author of the tag as herein described. The signature is stored in the memory 250 in a manner that permits reading but not amendment, i.e. it is read only.

The integration of the tags 10 at this stage reasonably ensures that the tags 10 are placed on genuine products and reduces the chance that tampering or other malicious activities can occur between production and delivery of a product. After manufacture of the product has been completed, the tag 10 appended to the item 16 can then be read and the signature verified by a tag reader 12. Assuming the signature verifies, information including the serial number, UID, other HAs, and product description can be uploaded to the database 312 in the web server 310 in a secure manner and stored at a location corresponding to the URL 302.

The tag reader 12 shown in FIG. 4 may conveniently be provided in a smart phone for utilisation by consumers and uses the processor 200 and memory 202 to verify the signature when reading a tag 10. The processor 200 may then format a query and the network communications module 206 used to communicate the query to the server 310.

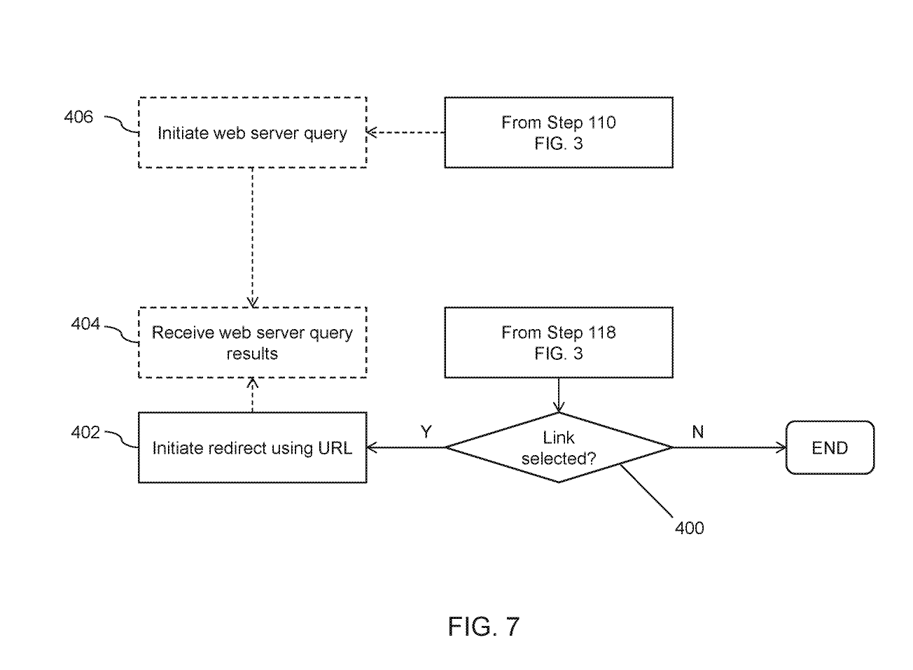

FIG. 7 illustrates steps taken by the tag reader 12 to enable a redirect link and optional web server query after validating a tag 10 at the tag reader 12. Referring also to FIG. 3, after reading the HA(s) 252 from the tag 10 and generating x′ at step 110, a web server query may optionally be initiated at step 406, as discussed below. Also, after outputting a successful tag verification at step 118, the tag reader 12 can be configured to determine whether or not a link associated with the URL 258 has been selected at step 400. When such a link is selected, the tag reader 12 can initiate a redirect using the URL 258 at step 402. If a web server query is also made, the web server query results are received at step 404, as explained by way of example below.

In this example, a link associated with the URL 258 can be displayed after a scanned tag 10 has been verified, as shown in FIG. 6. If the link is selected, a browser or app can be launched which provides access to a web site to which the user is redirected via the web server 310. At this time, the web server can record the successful verification and potentially obtain additional stats. The redirection is done through the web server 310 transparently to the user while allowing the manufacturer or other company (e.g. store) to have a secure and consistent landing point for such queries.

Optionally, the tag reader 12 can also send a query to the web server 310 using the serial number 260, HA 252, and/or other data to perform an additional check, to obtain additional information, etc. The results of the web query can also be displayed for the user. It can be appreciated that the operations shown in FIGS. 3 and 7, minus those that query the web server 310, can be considered an “offline” mode, wherein the information available to the reader 12 is used to perform the verifications. Such an offline mode can be considered advantageous in situations where privacy is of a concern, since data is not sent into the cloud or other connected environment. To that end, the tag reader 12, particularly when embodied as a smart phone or other personal electronic device can include user options to control offline versus online modes. Similarly, automatic controls can be implemented, e.g. to only perform online queries in purported secure areas with offline mode being used in public or insecure environments.

An example will now be discussed in which the serial number 260 is used to perform a web query. The data read by the tag reader 12 in this example includes the HA 252 such as the UID and the signature 254. The processor 200 verifies the signature 254 and extracts the message which includes the URL 258 and serial number 260. If the signature is invalid, an error condition will occur and an indication that the article may not be authentic is provided on the reader 12. This is attained without communicating with the web server 310 and provides an initial threshold for authenticity. If it is determined that the signature is valid, a query will be formatted and sent to the web server 310.

Where the comparison is to be performed at the reader 12, the query will include at least the serial number 260 associated with the item 16 and is directed to the URL 258 contained in the message, and whose authenticity has been verified. The target URL 258 is directed to a location in the database that correlates the serial number 260, the characteristics of the item 16, and the UID or other HA 252.

A query using the URL 258 will, therefore, extract the UID or other HA 252 and the product description associated with the serial number 260 for comparison at the phone containing the tag reader 12. This information is sent to the tag reader 12, which may then compare the received HA 252 and that on the tag itself. If the HAs match, the tag is considered authentic. The reader 12 may also display the characteristics of the item, e.g. Rolex watch with gold case, or an image of the item so the user can make a visual comparison to confirm the authenticity. Clone detection operations can also be performed, as discussed above, when it is determined that the signature is valid but not the HA(s) 252.

In this optional implementation, by signing the URL 258 and the serial number 260, the reader 12 may be assured that a trusted party has attested to the correctness of the URL and a spoof has not been substituted in the tag 10 by a counterfeiter. Where additional information or functionality is required, an optional URL redirection is provided in the database to facilitate production and to allow information from the alternative site to be included and forwarded to the reader 12. The URL 258 can be programmed in batches during manufacture and the redirect URL incorporated in the database subsequently. The redirect URL may also recover additional information. This may, for example be a list of additional features or a product comparison to competitor's devices. However, access to the optional URL does not compromise the initial direction to the target URL 258 that maintains the database on which the verification is based. The redirection URL may also be used to provide access to additional functions that are associated with the item 16. For example, the item 16 may be a car and the redirect accesses a service record of the car. In this case, the redirect may include a password protected link to the service record to control access to that site.

In the above embodiment, the query to the database 312 returns the HA(s) 252 associated with the serial number 260 to the reader 12 and the processor 200 in the reader 12 is used to compare the HAs 252. In an alternative arrangement, the comparison of HAs 252 can be performed by the server 310 and a simple message provided to the reader 12 indicating the authenticity or otherwise of the item 16.

To further enhance the performance of the system, the data string in the tag 10 may be modified such that the HA 252 is included in the message that is signed and stored on the tag 10. In this way the verification of the signature will also verify the HA 252 before being sent to the server 310.

Assuming the signature is valid, the URL 258 can be used to direct a query to the database 312. The query sent to the server 310 can include the HA 252 and serial number 260 read from the tag 10. The server 310 queries the database 312 using the URL 258 and serial number 260 and extracts the HA 252 associated with the serial number. Rather than sending the extracted HA 252 to the reader 12, the server 310 compares the HA 252 received from the reader 12 and that recovered from the data base 312 and if they are identical, sends a message to the reader 12 that the item 16 is authenticated. If they are not identical, a message indicating lack of authenticity can be sent.

As a further enhancement, the data string may include a signature of the HA 252, which is included in the query sent to the server 310. Upon receipt of the query, the server 310 verifies the signature, using the HA 252 sent as part of the query, to authenticate the HA 252 and complete the comparison with the HA recovered from database 312. Alternatively, the bandwidth may be reduced by sending only the signature from the reader 12. The signature is then verified using the HA 252 recovered from the database 312, and authenticity or otherwise assessed from the verification process.

The interaction between the reader 12 and the web server 310 facilitates the analysis of potential fraudulent operations. When deployed on a large scale, a manufacture of the item 16 can monitor every time a tag is read, producing powerful analytics. The user may just want product info (or service info) relating to the item 16, which is obtained by reading the tag 10. However, the manufacture will learn consumer behavior from the queries received, and will have any fraudulent tags, that is those that fail to verify the HAs 252, brought to his attention. This permits the nature of the fraudulent activity to be determined, for example, if fraudulent does it attempt to use the same HA 252, or are fraudulent activities occurring at the same location.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the tag reader 10, NFC module 30, web service 12, any component of or related to such entities, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of programming an identification tag, the tag comprising a cryptographic engine, the method comprising:
writing a random value to the tag as a private key;
reading at least one value identifying an attribute of the tag;
encrypting the at least one value using the private key to generate an encrypted value;
digitally signing the encrypted value to generate a digital signature; and
programming the tag to include the digital signature and the encrypted value.

2. The method of claim 1, wherein a hash of the at least one value is generated, and the hash of the at least one value is encrypted.

3. The method of claim 1, wherein the attribute of the tag corresponds to a hardware attribute determined or applied at a time of manufacture.

4. The method of claim 1, further comprising embedding the encrypted value into a uniform resource locator (URL), the URL being signed.

5. The method of claim 4, wherein the URL embeds a bit mask indicating the contents of the hash.

6. The method of claim 5, wherein the URL embeds a plurality of values identifying a plurality of attributes of the tag.

7. The method of claim 4, wherein the URL embeds a serial number associated with a product to which the tag is affixed or is to be affixed.

8. A method of verifying an identification tag, the tag comprising a cryptographic engine, the method comprising:
reading a signature stored on the tag;
verifying the signature;
reading at least one value identifying an attribute of the tag;
having the tag encrypt the at least one value using its cryptographic engine and a private key written to the tag to generate an encrypted value; and
comparing the encrypted value with an encrypted value stored on the tag, the encrypted value stored on the tag having been digitally signed to generate the signature stored on the tag.

9. The method of claim 8, wherein a hash of the at least one value is generated, and the hash of the at least one value is encrypted.

10. The method of claim 8, wherein the attribute of the tag corresponds to a hardware attribute determined or applied at a time of manufacture.

11. The method of claim 8, wherein the encrypted value is embedded into a uniform resource locator (URL), the URL being signed.

12. The method of claim 11, wherein the URL embeds a bit mask indicating the contents of the hash.

13. The method of claim 12, wherein the URL embeds a plurality of values identifying a plurality of attributes of the tag.

14. The method of claim 11, wherein the URL embeds a serial number associated with a product to which the tag is affixed or is to be affixed.

15. The method of claim 11, further comprising sending a query to a web server after detecting selection of the URL.

16. The method of claim 15, wherein selection of the URL is detected via an interaction with the tag reader, the tag reader displaying the URL.

17. The method of claim 15, further comprising receiving additional information from the web server.

18. The method of claim 17, wherein the additional information comprises at least one of: a confirmation of tag validity, product information associated with a product to which the tag is affixed, and an error message.

19. The method of claim 8, wherein if the signature is verified but the at least one values do not match, an error condition is detected indicative of a cloned tag.

20. The method of claim 19, further comprising sending a clone detection message to a third party.

21. An identification tag comprising a cryptographic engine and memory, the memory having been programmed by:
writing a random value to the tag as a private key;
reading at least one value identifying an attribute of the tag;
encrypting the at least one value using the private key to generate an encrypted value;
digitally signing the encrypted value to generate a digital signature; and
programming the tag to include the digital signature and the encrypted value.

22. The tag of claim 21, wherein the tag is a radio frequency identification (RFID) tag.

23. The tag of claim 22, wherein the RFID tag is a near field communication (NFC) tag.

24. A non-transitory computer readable medium comprising computer executable instructions for programming an identification tag, the tag comprising a cryptographic engine, the computer executable instructions comprising instructions for:
writing a random value to the tag as a private key;
reading at least one value identifying an attribute of the tag;
encrypting the at least one value using the private key to generate an encrypted value;
digitally signing the encrypted value to generate a digital signature; and
programming the tag to include the digital signature and the encrypted value.

25. A non-transitory computer readable medium comprising computer executable instructions for verifying an identification tag, the tag comprising a cryptographic engine, the computer executable instructions comprising instructions for:
reading a signature stored on the tag;
verifying the signature;
reading at least one value identifying an attribute of the tag;
having the tag encrypt the at least one value using its cryptographic engine and a private key written to the tag to generate an encrypted value; and
comparing the encrypted value with an encrypted value stored on the tag, the encrypted value stored on the tag having been digitally signed to generate the signature stored on the tag.

26. A device for programming identification tags, the device comprising a processor and memory, the memory comprising computer executable instructions for:
writing a random value to the tag as a private key;
reading at least one value identifying an attribute of the tag;
encrypting the at least one value using the private key to generate an encrypted value;
digitally signing the encrypted value to generate a digital signature; and
programming the tag to include the digital signature and the encrypted value.

27. A device for verifying identification tags, the device comprising a processor and memory, the memory comprising computer executable instructions for:
reading a signature stored on the tag;
verifying the signature;
reading at least one value identifying an attribute of the tag;
having the tag encrypt the at least one value using its cryptographic engine and a private key written to the tag to generate an encrypted value; and
comparing the encrypted value with an encrypted value stored on the tag, the encrypted value stored on the tag having been digitally signed to generate the signature stored on the tag.
